(19) United States
(12) Patent Application Publication
(10) Pub. No.: US 2015/0136264 A1
(43) Pub. Date: May 21, 2015

(54) FLEXIBLE PIPE BODY AND METHOD

(71) Applicant: Wellstream International Limited, Newcastle-upon-Tyne, Tyne and Wear (GB)

(72) Inventors: Gary Michael Holland, North Shields (GB); Geoffrey Stephen Graham, Newcastle (GB); Neville Dodds, Gateshead (GB); Upul Shanthilal Fernando, Sheffield (GB); Phillip Michael Hunter Nott, Newcastle (GB); George Henry Frank Hatherley, Prudhoe (GB); Mark Anthony Laycock, Thornaby (GB)

(73) Assignee: Wellstream International Limited, Newcastle-upon-Tyne, Tyne and Wear (GB)

(21) Appl. No.: 14/368,758

(22) PCT Filed: Oct. 24, 2012
(86) PCT No.: PCT/GB2012/052645

§ 371 Date: Jun. 25, 2014

(30) Foreign Application Priority Data
Dec. 28, 2011 (GB) 1122364.1

(51) Int. Cl. F17D 5/02; F16L 55/00; F16L 11/12; B32B 1/08; F16L 11/08

(52) U.S. Cl. CPC F17D 5/02; B32B 1/08; F16L 11/082; F16L 11/12; F16L 55/00; B32B 2307/51
USPC 138/104; 156/90; 138/137; 138/129; 138/106

(57) ABSTRACT

A flexible pipe body and method of manufacturing a flexible pipe body are disclosed. The flexible pipe body includes a fluid retaining layer for preventing ingress of fluid into the flexible pipe body from an environment outside of the flexible pipe body; and a fibre element arranged generally along a longitudinal axis of the fluid retaining layer.

This invention relates to flexible pipe body and method of manufacturing the same. Particularly, but not exclusively, the invention relates to the monitoring of parameters such as strain, temperature and/or acoustics in a flexible pipe. The parameters may be monitored in situ in flexible pipes in the oil and gas industry, for example.

There are many technical fields in which it is useful from time to time or continuously to monitor one or more parameters associated with a structure. For example, from time to time bridges, road surfaces, regions of land, lamp-posts, wind turbine blades, yacht masts, suspended power cables or the like should be repeatedly or continuously monitored so that information identifying any potential problems with the structure can be identified and then remedial action taken.

Traditionally flexible pipe is utilised to transport production fluids, such as oil and/or gas and/or water, from one location to another. Flexible pipe is particularly useful in connecting a sub-sea location (which may be deep underwater, say 1000 metres or more) to a sea level location. The pipe may have an internal diameter of typically up to around 0.6 metres. Flexible pipe is generally formed as an assembly of a flexible pipe body and one or more end fittings. The pipe body is typically formed as a combination of layered materials that form a pressure-containing conduit. The pipe structure allows large deflections without causing bending stresses that impair the pipe's functionality over its lifetime. The pipe body is generally built up as a combined structure including metallic and polymer layers.

Nonetheless, it will be appreciated that harsh environmental conditions are present at such operating depths under the sea, including not only high pressures and strong tidal movement but also man-made conditions such as collision with passing vehicles and so on.

In relation to all structures, many different forces will be experienced. This can lead to very complex loads and includes, but is not limited to, self-weight, internal pressure, tension, vortex induced vibration, flexing, twisting or the like.

There is an increasing desire for the continual monitoring of various parameters of flexible pipes, such as strain, temperature and acoustics, to help detect structural failures in the pipe. Such structural failure could be leakage, wire breakage, over-bending in the pipe (i.e. bending past the maximum allowable amount before which damage will occur), and interaction between the pipe and external environment such as collisions with other objects, for example.

One way which has been suggested for monitoring parameters associated with such structures is the use of an optical fibre system. As a method of monitoring strain, temperature and acoustics in flexible pipe, bare fibres and/or fibres in metal tubes (FIMT) within a protective conduit have been incorporated along the length of the pipe structure and connected to an interrogating device external of the pipe. The fibre is used as an optical fibre for transmitting light and is generally made of glass. The optical fibres can be used as strain gauges, temperature gauges, temperature indicators and strain measurements can be made which are either localised, distributed or semi-distributed depending upon the manner in which the optical fibre is interrogated and regions/sensors in the optical fibre are arranged. The fibres may include Bragg Gratings whereby differential diffraction of light passing down the fibre is used to measure the necessary parameter. Output readings can be analysed to determine the conditions of the pipe over a time period and corrective action can be taken accordingly. WO2009/068907, the disclosure of which is incorporated herein in its entirety, discloses a way in which an optical fibre can be wrapped around a flexible pipe and certain measurements taken from which parameters associated with the pipe can be determined.

Whilst such a system does enable certain parameters associated with the pipe to be determined there are limits within which such an optical system can be used. One reason for this is because optical fibres are inherently relatively fragile and if the underlying structure which is being monitored is prone to substantial mechanical movement then mechanical stresses and strains can be induced in the fibre which causes fibre failure. Therefore, the use of optical fibre has until now been limited to uses where the movement of the optical fibres has been unduly limited.

Strain limitations based on the Ultimate Tensile Strain (UTS) of fibre optic cables are currently in the region of 1% according to manufacturers recommendations. The use of commercially available optical fibres to measure strains above 1% thus requires a method of reducing the amount of strain that the fibre is subjected to thereby increasing its capability to measure strain levels beyond its UTS limit.

Known methods may use the pressure armour and/or tensile armour wires to carry the conduit. A groove is formed into the side edge of the wire form, into which the conduit is laid and bonded into position. When the pipe is subjected to forces, the conduit therefore experiences the same conditions via this bond to the wires. The fibres etched with Bragg gratings, which are bonded to the inside of the conduit, record the movement experienced by the conduit and thus strain monitoring is achieved.

Temperature can be monitored by including a FIMT that is not bonded to the inside of the conduit, and is therefore able to record temperature independently to strain. Fibres can be configured in a similar manner to monitor acoustic conditions.

Assembling the conduits into the wire, and their eventual removal from the wire at the end fitting stage to enable their connection to the interrogating device, are the challenges faced with the known methods. In terms of preparation, the forming of the initial groove in the wire that will carry the conduit is governed by wire hardness; excessively hard or soft wire can make it difficult to create the required groove geometry. In addition, production time is extended since the conduit must be fitted and bonded into the wire's groove prior to applying the armour layer. At pipe completion when the end fitting is assembled, the conduits must be separated from the armour wires to facilitate their connection to an external device. As the conduits are bonded into the wire, removing them from the groove is difficult and can induce unnecessary stress in the material.

It is an aim of the present invention to at least partly mitigate the above-mentioned problems.

It is an aim of embodiments of the present invention to provide an apparatus and method for monitoring parameters associated with an elongate structure such as a flexible pipe.

It is an aim of embodiments of the present invention to enable a fibre to be incorporated into a pipe structure relatively easily during manufacture compared to known configurations.

According to a first aspect of the present invention there is provided a flexible pipe body, comprising:
a fluid retaining layer for preventing ingress of fluid into the flexible pipe body from an environment outside of the flexible pipe body; and
a fibre element arranged generally along a longitudinal axis of the fluid-retaining layer.

According to a second aspect of the present invention there is provided a method of manufacturing a flexible pipe, comprising:
providing a fluid retaining layer for preventing ingress of fluid into the flexible pipe body from an environment outside of the flexible pipe body;
providing a fibre element arranged generally along a longitudinal axis of the fluid-retaining layer.

Certain embodiments of the invention provide the advantage that a fibre element for measuring parameters such as strain, temperature and the like can be incorporated into a flexible pipe body cheaply and conveniently. Certain embodiments provide this advantage without requiring additional forming steps to prepare a groove for the fibre to be housed in.

Certain embodiments of the invention provide the advantage that a parameter such as strain, temperature and the like can be monitored in a flexible pipe continuously or repeatedly, at desired times or when triggered by the occurrence of a predetermined event.

Embodiments of the invention are further described hereinafter with reference to the accompanying drawings, in which:

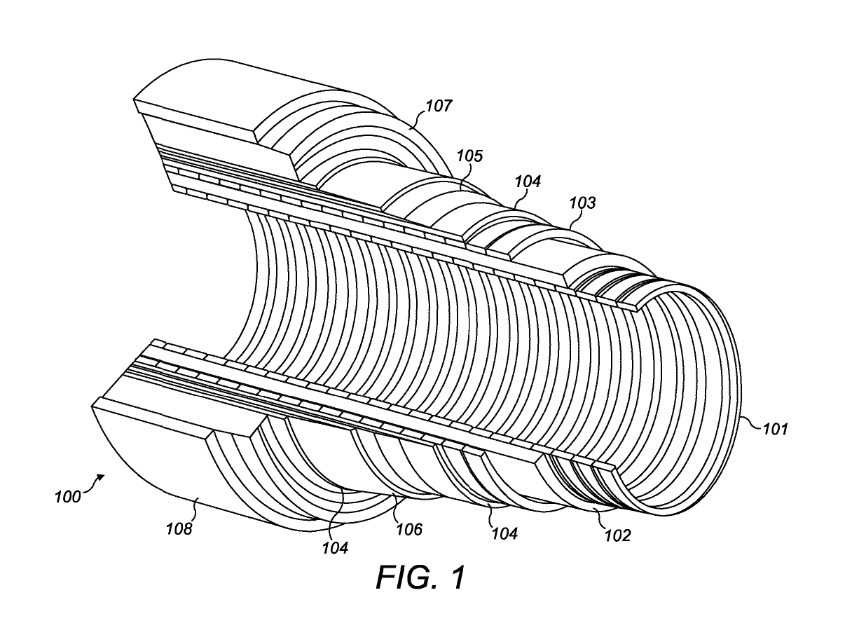

FIG. 1 illustrates a flexible pipe body;

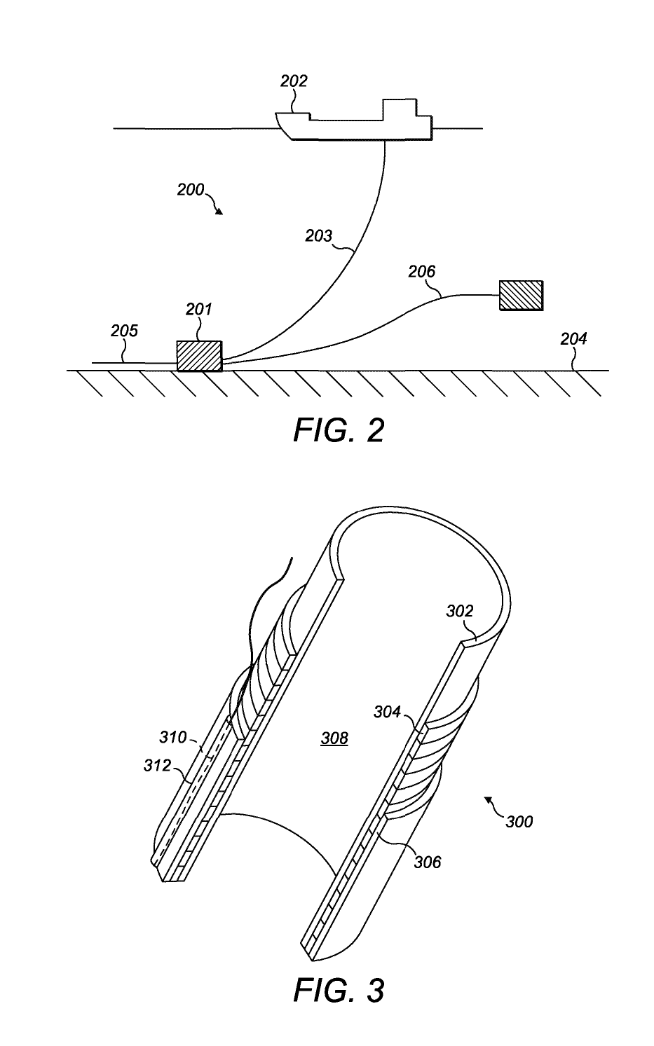

FIG. 2 illustrates a riser assembly;

FIG. 3 illustrates a pipe body of an embodiment of the invention;

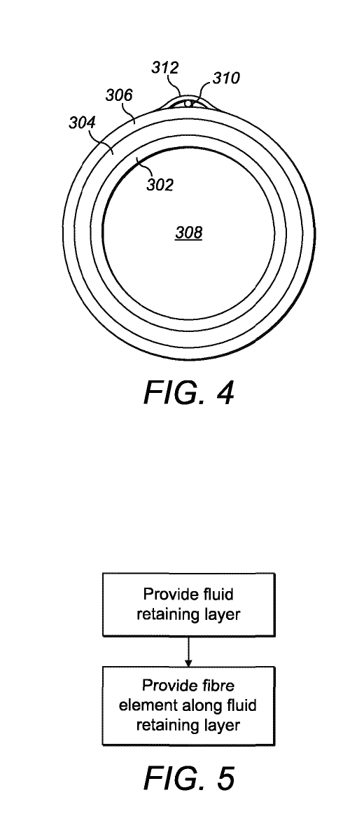

FIG. 4 illustrates a cross section of the pipe body of FIG. 3;

FIG. 5 illustrates a method of providing a pipe body;

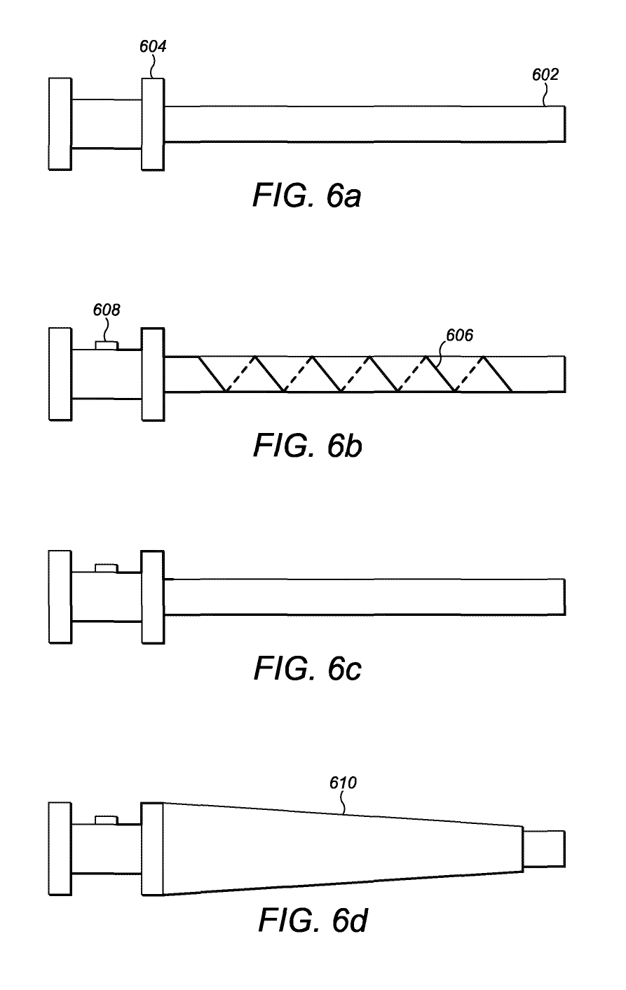

FIGS. 6a to 6d illustrate a further method of providing a pipe body;

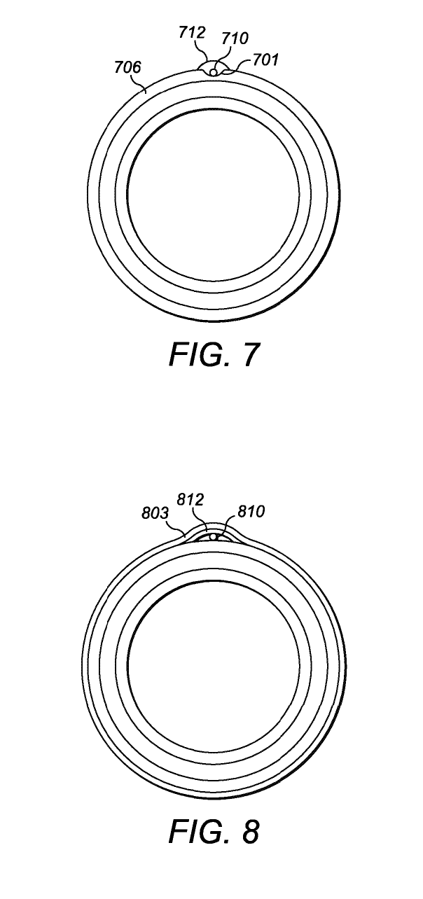

FIG. 7 illustrates a cross section of another pipe body; and

FIG. 8 illustrates a cross section of a yet further pipe body.

In the drawings like reference numerals refer to like parts.

Throughout this description, reference will be made to a flexible pipe. It will be understood that a flexible pipe is an assembly of a portion of a pipe body and one or more end fittings in each of which a respective end of the pipe body is terminated. FIG. 1 illustrates how pipe body 100 is formed in accordance with an embodiment of the present invention from a combination of layered materials that form a pressure-containing conduit. Although a number of particular layers are illustrated in FIG. 1, it is to be understood that the present invention is broadly applicable to coaxial pipe body structures including two or more layers manufactured from a variety of possible materials. It is to be further noted that the layer thicknesses are shown for illustrative purposes only.

As illustrated in FIG. 1, a pipe body includes an optional innermost carcass layer 101. The carcass provides an interlocked construction that can be used as the innermost layer to prevent, totally or partially, collapse of an internal pressure sheath 102 due to pipe decompression, external pressure, and tensile armour pressure and mechanical crushing loads. It will be appreciated that certain embodiments of the present invention are applicable to ‘smooth bore’ operations (i.e. without a carcass) as well as such ‘rough bore’ applications (with a carcass).

The internal pressure sheath 102 acts as a fluid retaining layer and comprises a polymer layer that ensures internal fluid integrity. It is to be understood that this layer may itself comprise a number of sub-layers. It will be appreciated that when the optional carcass layer is utilised the internal pressure sheath is often referred to by those skilled in the art as a barrier layer. In operation without such a carcass (so-called smooth bore operation) the internal pressure sheath may be referred to as a liner.

An optional pressure armour layer 103 is a structural layer with a lay angle close to 90° that increases the resistance of the flexible pipe to internal and external pressure and mechanical crushing loads. The layer also structurally supports the internal pressure sheath, and typically consists of an interlocked construction.

The flexible pipe body also includes an optional first tensile armour layer 105 and optional second tensile armour layer 106. Each tensile armour layer is a structural layer with a lay angle typically between 10° and 55°. Each layer is used to sustain tensile loads and internal pressure. The tensile armour layers are often counter-wound in pairs.

The flexible pipe body shown also includes optional layers of tape 104 which help contain underlying layers and to some extent prevent abrasion between adjacent layers.

The flexible pipe body also typically includes optional layers of insulation 107 and an outer sheath or fluid retaining layer 108, which comprises a polymer layer used to protect the pipe against penetration of seawater and other external environments, corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a riser assembly 200 suitable for transporting production fluid such as oil and/or gas and/or water from a sub-sea location 201 to a floating facility 202. For example, in FIG. 2 the sub-sea location 201 includes a sub-sea flow line. The flexible flow line 205 comprises a flexible pipe, wholly or in part, resting on the sea floor 204 or buried below the sea floor and used in a static application. The floating facility may be provided by a platform and/or buoy or, as illustrated in FIG. 2, a ship. The riser assembly 200 is provided as a flexible riser, that is to say a flexible pipe 203 connecting the ship to the sea floor installation. The flexible pipe may be in segments of flexible pipe body with connecting end fittings.

It will be appreciated that there are different types of riser, as is well-known by those skilled in the art. Embodiments of the present invention may be used with any type of riser, such as a freely suspended (free, catenary riser), a riser restrained to some extent (buoys, chains), totally restrained riser or enclosed in a tube (I or J tubes).

FIG. 2 also illustrates how portions of flexible pipe can be utilised as a flow line 205 or jumper 206.

FIG. 3 illustrates a cut-away portion of a flexible pipe body 300 according to an embodiment of the present invention. Here the pipe body includes an inner fluid retaining layer (liner) 302, a pressure armour layer 304 and an outer fluid retaining layer (outer sheath) 306. The inner liner 302 prevents or slows fluid from permeating from the inner bore region 308 to any radially outer layers of the pipe body and the external environment. The pressure armour layer 304 increases the resistance of the flexible pipe to internal and external pressure and mechanical crushing loads, as is known in the art. The outer fluid retaining layer 306 prevents the ingress of fluid into the flexible pipe body from the external environment (e.g. preventing sea water from entering the flexible pipe body) in use. The outer fluid retaining layer may be a polymer layer or of composite material, for example.

The outer fluid retaining layer 306 also has a fibre optic element 310 arranged along the length of the layer, which may be of glass, and may be a polyamide coated fibre, for example. The fibre 310 is adhered to the fluid retaining layer 306 with strain gauge adhesive or other suitable bonding agent. A body of polymer 312 is then applied over the fibre 310 as a protector to help protect the fibre from the external environment. This is shown in the cross-sectional diagram of FIG. 4. Alternatively, the bonding agent may be used as a preliminary bonding means, and the polymer body used as a further bonding agent. The polymer body may be applied in molten (liquid) form so as to help seal the fibre thereunder.

In use, the fibre 310 may be operably connected to a sensing device or interrogation device for the monitoring of strain, temperature and/or acoustic properties. In this embodiment, since the fibre 310 is bonded along the full length of its contact with the fluid retaining layer 306, the fibre can be used to measure strain properties. In one embodiment of the invention, the fibre may be provided on the flexible pipe body (prior to or after attachment to one or more end fitting), and then a bend stiffener device applied over the pipe body. It is noted that the area of flexible pipe body under a bend stiffener can often be the section of pipe body that undergoes the highest degree of stretching, bending and, stress and strain, and is therefore generally one of the areas of most interest to those monitoring the flexible pipe performance. As such, the fibre 310 may be located along the portion of the flexible pipe body of interest in a looped manner, with both ends of the fibre provided conveniently in the area of the end fitting. In other embodiments the fibre may be provided with a first end in the region of a first end fitting and a second end in the region of a second, distal end fitting or other region, for example. In this embodiment the fibre includes Fibre Bragg Gratings (FBGs) for high frequency strain response measurements, although a distributed system as known in the art could alternatively be used.

A distributed measurement uses a length of fibre optic as a sensor. The smallest length of strain (or other measurement) cannot be any shorter than the length of fibre used to measure it. Typically this is around 1 metre. If it is required to measure strain at a specific point the Bragg Gratings are more useful as their length is only a few mm each. These are part of the optical fibre and placed onto a flexible pipe in the same way as a distributed system fibre. Bragg Gratings provide measurements at very well defined small segments of pipe.

A method of manufacturing a flexible pipe body according to an embodiment of the invention is illustrated in FIG. 5. In a first step, an outer fluid retaining layer is provided, i.e. a layer for preventing ingress of fluid into the pipe body. The fluid retaining layer may be extruded in a generally cylindrical manner, for example. In a second step, a fibre element is provided generally along a longitudinal axis of the fluid retaining layer. This step may be performed manually or automated. It will be appreciated that these steps could be carried out at the same time, with the fibre element being applied to the layer at substantially the same time as the layer is formed (by extrusion for example).

FIGS. 6a to 6d illustrate a further method of manufacturing a flexible pipe according to an embodiment of the invention. In FIG. 6a, a flexible pipe body 602 is connected with an end fitting 604, in a manner known in the art. In FIG. 6b, a fibre 606 is helically wrapped and bonded to the pipe body 602, and connected to a sensing device 608. In FIG. 6c a polymer body is applied to the pipe body covering the fibre 606 such that the fibre is not visible in the schematic drawing. The polymer body may be applied to cover the fibre using a polymer welding gun for example. In FIG. 6d, a bend stiffener 610 is applied over the portion of flexible pipe body and attached to the end fitting 604.

The term ‘outer fluid retaining layer’ (or outer sheath) is used above since this layer prevents ingress of fluid and is provided radially outwards of other pipe body layers. This is therefore different to the radially inner fluid retaining layer (or barrier layer or liner), which also functions to retains fluid. It will be realised that even though the term outer fluid retaining layer is used, this layer need not be the outermost layer of the flexible pipe body, and the pipe body may include further layers provided radially outwards of this outer fluid retaining layer.

In another embodiment of the present invention, a grooved area 701 is formed in the outer fluid retaining layer 706 for receiving a fibre element 710. Then, a body of polymer or other suitable material is applied over the fibre in the same manner as described above with respect to FIG. 4.

In a yet further embodiment of the present invention, the formed layer including fibre 810 and optionally body 812 may be provided with a further outer layer 803 for providing further protection to the fibre element. The pipe body of FIG. 4 or 7 for example could be wrapped with a tape such as Canusa tape™ or polymer tape or similar. Alternatively, a heat shrink sleeve could be applied over the entire layer.

The above described invention provides a cost effective and relatively simple way of providing a flexible pipe with monitoring capabilities compared to known designs.

Additionally, current pipe manufacturing methodology is barely changed, making it attractive to manufacturers and customers alike.

With the above described invention, the strain present in a flexible pipe body can be sensed, monitored, and profiled. From these measurements, the curvature of the pipe shape can be deduced, and the data can be used to assist in fatigue life predictions, or used to calibrate system models, for example. In other embodiments the temperature and/or acoustics for example may be monitored. By monitoring these parameters, the results can be used to check heat build up within the pipe layers, temperature change for example due to a flooded annulus, etc.

With the above described invention, when the fibre element is provided in the outer fluid retaining layer, the fibre can be easily applied to the pipe body after the remainder of the pipe body has already been manufactured, thus reducing the strain that the fibre is subjected to during the manufacturing process. The fibre may be completely retrofitted to a flexible pipe that already has the end fitting in place.

With the above described invention, the provision of the fibre in the outer fluid retaining layer obviates the need for more difficult, time consuming and/or performance-affecting (integrity reducing) procedures in forming a groove in a metal armour layer and applying a fibre to the groove as per known methods.

However, by providing the fibre element in a groove of the fluid retaining layer, this does help to prevent the fibre element from being damaged due to movement of the pipe, and so on. Formation of a groove in a polymer fluid retaining layer will generally be more readily possible and less time consuming than forming a groove in a metal armour layer.

Various modifications to the detailed designs as described above are possible. For example, although the fibre element has been described above to extend generally along the outer fluid retaining layer (i.e. parallel to the longitudinal axis of the pipe body), the fibre element could alternatively be wound in a helical fashion around the fluid retaining layer. Wrapping a fibre generally helically is advantageous because strain in the fibre will be lower than the strain experienced by the pipe body (due to its relatively longer length).

Although the above-described fibre has been described as bonded to the fluid retaining layer along its length, the fibre may be bonded in only certain portions. The portions where the fibre is not bonded may enable temperature measurements to be taken, as will be known by a person skilled in the art.

Although the protective body 312 is described above as a polymer, it could alternatively be a composite material or other such suitable material.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe body, comprising:
a fluid retaining layer for preventing ingress of fluid into the flexible pipe body from an environment outside of the flexible pipe body; and
a fibre element arranged generally along a longitudinal axis of the fluid retaining layer.

2. A flexible pipe body as claimed in claim 1, further comprising
a fluid retaining liner or barrier layer for preventing or slowing fluid permeating from an inner bore of the pipe body to radially outer layers of the pipe body, and
a pressure armour layer provided between the fluid retaining liner or barrier layer and the fluid retaining layer.

3. A flexible pipe body as claimed in claim 1 wherein the fibre element is bonded to the fluid retaining layer along a portion of, or all of, the length of fibre element.

4. A flexible pipe body as claimed in claim 1 further comprising a protector element provided over and radially outwards of the fibre element, such that the fibre element is enclosed between the fluid retaining layer and the protector element.

5. A flexible pipe body as claimed in claim 4 wherein the protector element is a body of polymer or composite material.

6. A flexible pipe body as claimed claim 1 wherein the fibre element is provided in a grooved region of the fluid retaining layer.

7. A flexible pipe body as claimed in claim 1, further comprising a sheath element provided radially outwards of the fluid retaining layer and the fibre element.

8. A flexible pipe body as claimed in claim 7 wherein the sheath element comprises a heat shrink tape or sleeve.

9. A flexible pipe body as claimed in claim 7 wherein the sheath element comprises a wrapped tape element.

10. A flexible pipe body as claimed in claim 1 wherein the fibre element is arranged substantially helically around the fluid retaining layer.

11. A flexible pipe body as claimed in claim 1 wherein the fibre element includes Fibre Bragg Gratings.

12. A flexible pipe body as claimed in claim 1 wherein the fibre element is arranged as a Distributed Temperature System (DTS).

13. A flexible pipe body as claimed in claim 1 wherein the fibre element is connectable to a sensing device for monitoring one or more parameter associated with the flexible pipe.

14. A flexible pipe comprising the flexible pipe body of claim 1 and an end fitting connected to one end of the flexible pipe body.

15. A flexible pipe as claimed in claim 13 further comprising a bend stiffener element provided over a portion of the flexible pipe body.

16. A method of manufacturing a flexible pipe, comprising:
providing a fluid retaining layer for preventing ingress of fluid into the flexible pipe body from an environment outside of the flexible pipe body;
providing a fibre element arranged generally along a longitudinal axis of the fluid-retaining layer.

17. A method as claimed in claim 16 further comprising:
providing a fluid retaining liner or barrier layer for preventing or slowing fluid permeating from an inner bore of the pipe body to radially outer layers of the pipe body; and
providing a pressure armour layer provided between the fluid retaining liner or barrier layer and the fluid retaining layer.

18. A method as claimed in claim 16 further comprising bonding the fibre element to the fluid retaining layer along a portion of, or all of, the length of fibre element.

19. A method as claimed in claim 16 further comprising providing a protector element provided over and radially outwards of the fibre element, such that the fibre element is enclosed between the fluid retaining layer and the protector element.

20. A method as claimed in claim 16 further comprising forming a grooved region in the fluid retaining layer for housing the fibre element.

21. A method as claimed in claim 16 further comprising providing a sheath element radially outwards of the fluid retaining layer and the fibre element.

22. A method as claimed in claim 16 further comprising wrapping the fibre element around the fluid retaining layer substantially helically.

23. A method as claimed in claim 16 further comprising connecting the fibre element to a sensing device for monitoring one or more parameter associated with the flexible pipe.

24. (canceled)

25. (canceled)
